(19) United States
(12) Patent Application Publication
(10) Pub. No.: US 2025/0224299 A1
(43) Pub. Date: Jul. 10, 2025

(54) LIQUID OCCLUSION DETECTION AND EJECTION FOR PRESSURE SENSORS

(71) Applicant: Apple Inc., Cupertino, CA (US)

(72) Inventors: Vincenzo COSTANZA, San Diego, CA (US); Matthias IKEDA, Cupertino, CA (US)

(21) Appl. No.: 18/948,184

(22) Filed: Nov. 14, 2024

Related U.S. Application Data
(60) Provisional application No. 63/619,682, filed on Jan. 10, 2024.

(51) Int. Cl. G01L 27/00; G01D 3/036; G01L 19/00; G01L 19/14; H01F 7/06

(52) U.S. Cl. CPC G01L 27/007; G01D 3/0365; G01L 19/0092; G01L 19/147; H01F 7/064

(57) ABSTRACT

Aspects of the subject technology relate to electronic devices with pressure sensors. Pressure sensor occlusion may be mitigated by ejecting occluding liquid with a repulsive force from a motion generated with a magnetic actuator associated with the pressure sensor. Processing circuit of the electronic device can detect that the opening is occluded. The processing circuitry activates, when an occlusion is detected, the magnetic actuator by applying an electrical current to a coil in the magnetic actuator and ejects the liquid occlusion in the opening by generating a mechanical motion with a magnet in the magnetic actuator based on the applied electrical current to the coil.

### CROSS-REFERENCE TO RELATED APPLICATION(S)

This application claims the benefit of U.S. Provisional Application Ser. No. 63/619,682, entitled “LIQUID OCCLUSION DETECTION AND EJECTION FOR PRESSURE SENSORS,” and filed on Jan. 10, 2024, the disclosure of which is expressly incorporated by reference herein in its entirety.

### TECHNICAL FIELD

The present description relates generally to portable electronic devices, and more particularly, but not exclusively, to portable electronic devices with pressure sensors.

### BACKGROUND

Electronic pressure sensors are often used to obtain barometric pressure measurements for elevation and/or weather measurements. However, challenges can arise when attempting to implement an electronic pressure sensor in a portable electronic device.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a schematic diagram of an electronic device having a pressure sensor in accordance with various aspects of the subject technology.

FIG. 2 illustrates a perspective view of an example electronic device implemented as a wearable device in accordance with various aspects of the subject technology.

FIG. 3A illustrates a cross-sectional side view of a pressure sensor disposed in a pressure sensor port in a housing of an electronic device in accordance with various aspects of the subject technology.

FIG. 3B illustrates a top view of a protective cap for a pressure sensor in accordance with various aspects of the subject technology.

FIG. 4A illustrates a cross-sectional side view of a pressure sensor and an example of a magnetic actuator disposed in a housing of an electronic device in accordance with various aspects of the subject technology.

FIG. 4B conceptually illustrates a perspective view of the magnet in the magnetic actuator in accordance with various aspects of the subject technology.

FIG. 5 illustrates a cross-sectional side view of a pressure sensor and another example of a magnetic actuator disposed in a housing of an electronic device in accordance with various aspects of the subject technology.

FIG. 6 illustrates a cross-sectional side view of a pressure sensor and yet another example of a magnetic actuator disposed in a housing of an electronic device in accordance with various aspects of the subject technology.

FIG. 7 illustrates a cross-sectional side view of a pressure sensor and an example of a magnetic actuator and a heater disposed in a housing of an electronic device in accordance with various aspects of the subject technology.

FIG. 8A illustrates a pressure sensor and an example of a magnetic actuator with sensing and driving circuits in accordance with various aspects of the subject technology.

FIGS. 8B-8E conceptually illustrate equivalent circuits of the pressure sensor and magnetic actuator with the sensing and driving circuits of FIG. 8A in accordance with various aspects of the subject technology.

FIG. 8F illustrates a two-dimensional graph depicting a plot of an example sensing mechanism with the magnetic actuator of FIG. 8A in accordance with various aspects of the subject technology.

FIG. 9 illustrates a flow chart of an example process for taking corrective action for an identified pressure sensor occlusion in accordance with various aspects of the subject technology.

FIG. 10 illustrates a flow chart of an example process for liquid occlusion detection and ejection in accordance with various aspects of the subject technology.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The cross-sectional views in the accompanying drawings may not necessarily include cross-hatching. Accordingly, neither the presence nor the absence of cross-hatching conveys or indicates any preference or requirement for particular materials, material properties, element proportions, element dimensions, commonalities of similarly illustrated elements, or any other characteristic, attribute, or property for any element illustrated in the accompanying figure. Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

Portable electronic devices such as a mobile phones, portable music players, smart watches, and tablet computers are provided that include a pressure sensor for sensing environmental pressure. The pressure sensor is sometimes used for barometric pressure measurements, which can be used to identify changes in elevation. The changes in elevation are sometimes used to identify a location or exercise performed by a user of the device (e.g., by an activity monitor application running on processing circuitry of the device when the device is worn or carried by the user while the user walks or runs up a flight of stairs or up a hill).

Pressure sensors are disposed within a housing of the portable electronic device and can sense the environmental pressure outside the housing due to airflow from outside the housing into the housing at various openings or ports. Similarly, a microphone may be disposed within the housing of the portable electronic device and can output audible sound through an opening or port in the housing. However, the opening, and/or an internal volume of the port within which the pressure sensor and/or microphone is disposed, can become occluded by environmental aggressors such as a liquid, a portion of a user's skin, or a piece of clothing at or near the port, all of which can alter the performance of the sensor.

The performance of a liquid occluded pressure sensor or microphone can be adversely affected. This degradation occurs because the liquid can block airflow to the sensor (occlusion) and capillary forces can pull on the sensing membrane or waterproofing gel. In the case of occlusion, the pressure at the sensor may no longer equalize to the outside air, and any volume from evaporation can create a false pressure signal. In the case of a microphone, occlusion can block sounds, and bursting of bubbles and membrane can create sounds that are detected as very loud.

The pressure sensor can generate substantial errors in pressure readings when the pressure sensor becomes wet. These errors may demonstrate significant fluctuations in the pressure readings. These errors can occur due to capillary forces exerting an additional force on the pressure sensor, causing a consequential pressure error. To mitigate the error occurrences, traditional approaches have involved temporarily restricting pressure data transmission from the device for a defined duration of time (e.g., an hour) to allow for the trapped liquid to evaporate from the occluded space.

The subject technology addresses the challenge of unreliable pressure sensor data due to occluding liquid infiltration and the inability to ascertain when the occluding liquid dissipates. As such, the subject technology provides for detecting and expelling the occluding liquid, thereby resolving the need to indefinitely suspend pressure readings for extended periods, often longer than required. The aim is to expedite the evaporation process, reducing the time from hours to mere seconds or minutes, rather than relying on a passive waiting period due to the absence of sensing or feedback mechanisms as in traditional approaches.

Embodiments of the subject technology mitigates occlusion in a pressure sensor by removal of the liquid occlusion with a magnetic actuator to create a syringe-like mechanism. The magnetic actuator includes a magnet capable of traversing within a pocket formed adjacent to the pressure sensor, encircled by a coil. The magnetic actuator may employ the coil to manipulate the magnet's movement, facilitating the expulsion of trapped liquid by leveraging this motion. Additionally, the positioning of the magnet can vary depending on implementation to optimize the efficacy of this magnetic actuator.

The primary cause of the liquid occlusion is typically the presence of a particulate protection element in the portable electronic device, such as a mesh or a protective cap. For example, a liquid film will form within apertures of the particulate protection element thus leading to the occlusion of liquid, and therefore obstructing pressure transmission. In accordance with various aspects of the subject disclosure, a portable electronic device is provided that includes a pressure sensor and a magnetic actuator disposed within a housing of the portable electronic device. Processing circuitry in the portable electronic device identifies occlusions of the pressure sensor and expels the occluding liquid with the magnetic actuator by exerting a repulsive force onto the occluding liquid, as described in further detail hereinafter. The magnetic actuator may be implemented as a coil and magnet arrangement, where at least one coil is intended for sensing purposes and the remaining coils with the magnet are intended for performing the expulsion.

In cases where liquid obstructs the apertures of the particulate protection element rather than filling a cavity of the pressure sensor, the subject technology facilitates adjusting the protective cap's movement frequency. By increasing the protective cap's movement speed, these liquid droplets can be destabilized, facilitating the unclogging of the apertures and restoring airflow, thus rectifying the pressure imbalance within the cavity of the pressure sensor. The subject technology also provides for addressing particle accumulation within the internal volume (Pᵢₙₜ) of the pressure sensor, where particles, exposed to substances such as sunscreen or fine sands, form a hardened crust. These particles, when trapped within the pressure sensor's water-containing volume, contribute to a substantial pressure error. The subject technology, through its motion, aims to disrupt this crust by utilizing the magnet's movement. In one or more implementations, the magnetic actuator's motion can potentially break the hardened crust formed by particle accumulation within the pressure sensor. In one or more other implementations, by employing a more rounded protective cap that interfaces with the waterproofing gel, the magnet's motion can serve as a self-test mechanism, ensuring the pressure sensor's operational functionality. In one or more other implementations, the magnetic actuator can be implemented to operate with microphones to resolve similar issues encountered by microphones.

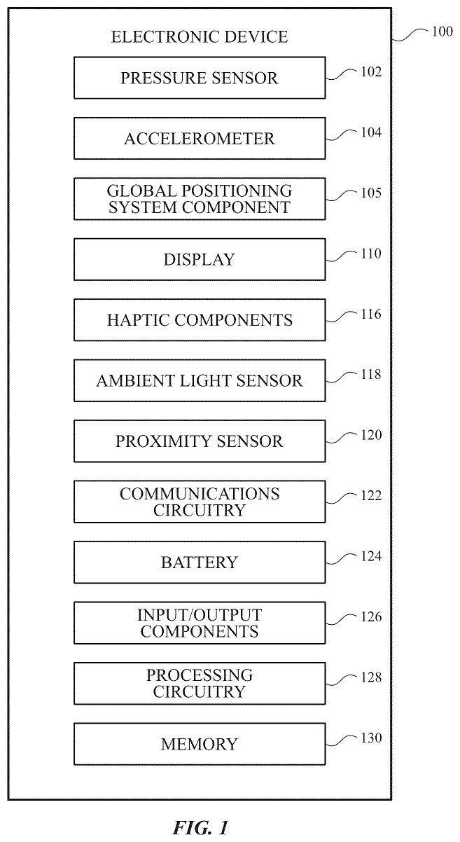

A schematic block diagram of an illustrative electronic device with a pressure sensor is shown in FIG. 1. In the example of FIG. 1, device 100 includes pressure sensor 102. Pressure sensor 102 includes a pressure sensing element (e.g., a micro-electromechanical system (MEMS) element, a piezo element, a membrane coupled to a capacitive or resistive transducer circuit, etc.) and may include processing circuitry 128 for the pressure sensor 102. The pressure sensor 102 may include a magnetic actuator. The magnetic actuator may be operated by processing circuitry 128 to help clear a liquid occlusion by expelling the occluding liquid by exerting a repulsive force onto the occluding liquid trapped within a cavity of the pressure sensor 102 to force the occluded liquid to expel out through an opening or port of the device 100.

Device 100 also includes processing circuitry 128 and memory 130. Memory 130 may include one or more different types of storage such as nonvolatile memory (e.g., flash memory or other electrically-programmable-read-only memory), volatile memory (e.g., static or dynamic random-access-memory), magnetic or optical storage, permanent or removable storage and/or other non-transitory storage media configure to store static data, dynamic data, and/or computer readable instructions for processing circuitry 128. Processing circuitry 128 may be used in controlling the operation of device 100. Processing circuitry 128 may sometimes be referred to as system circuitry or a system-on-chip (SOC) for device 100.

Processing circuitry 128 may include a processor such as a microprocessor and other suitable integrated circuits, multi-core processors, one or more application specific integrated circuits (ASICs) or field programmable gate arrays (FPGAs) that execute sequences of instructions or code, as examples. In one suitable arrangement, processing circuitry 128 may be used to run software for device 100, such as activity monitoring applications, pressure sensing applications, acceleration sensing application, occlusion detection applications using pressure data and accelerometer data, internet browsing applications, email applications, media playback applications, operating system functions, software for capturing and processing images, software implementing functions associated with gathering and processing sensor data, software that controls audio, visual, and/or haptic functions.

In the example of FIG. 1, device 100 also includes display 110, communications circuitry 122, battery 124, and input/output components 126. Input/output components 126 may include a touch-sensitive layer of display 110, a keyboard, a touch-pad, and/or one or more real or virtual buttons. Input/output components 126 may also include audio components such as one or more speakers and/or one or more microphones. In some scenarios, a speaker membrane or a microphone membrane can be operated to move air to affect and/or clear occlusions of one or more ports in a housing of device 100.

Communications circuitry 122 may be implemented using WiFi, near field communications (NFC), Bluetooth®, radio, microwave, and/or other wireless and/or wired communications circuitry. Communications circuitry 122 may be operated by processing circuitry 128 based on instructions stored in memory 130 to perform cellular telephone, network data, or other communications operations for device 100. Communications circuitry 122 may include WiFi and/or NFC communications circuitry operable to communicate with an external device such a mobile telephone or other remote computing device. In some scenarios, data communications with an external device such as communications by circuitry 122 of a smart watch with a host mobile phone may allow the use of data from the external device, in combination with pressure sensor data and/or acceleration data from the watch to identify and/or characterize a pressure sensor occlusion.

As shown in FIG. 1, device 100 may include other components such as a global positioning system (GPS) component 105, haptic components 116 (e.g., one or more vibratory or other actuable devices that can produce tactile responses for a user and/or other desired accelerations of device 100), and/or other sensors such as ambient light sensor 118 and/or proximity sensor 120. Device 100 also includes accelerometer 104, which includes electronic components that generate an acceleration signal responsive to physical accelerations of the accelerometer 104 (e.g., due to acceleration of device 100).

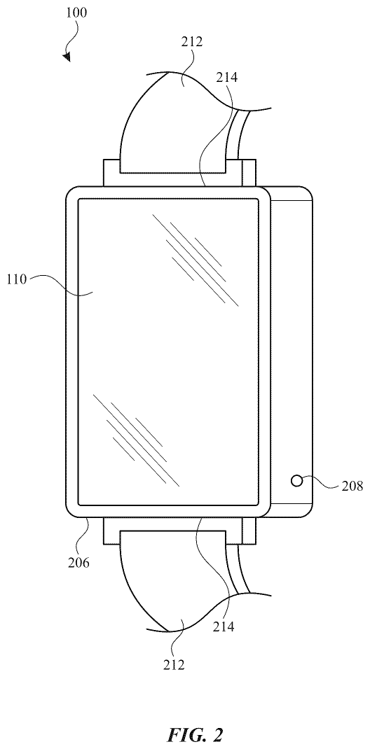

FIG. 2 is a perspective view of electronic device 100 in a configuration in which electronic device 100 has been implemented in the form of a wearable device such as a smart watch. As shown in FIG. 2, display 110 may be disposed on a front surface of housing 206. Housing 206 may include one or more openings such as opening 208. In the example of FIG. 2 opening 208 is formed in a sidewall of housing 206 and provides a fluid coupling for airflow between an environment external to housing 206 into a portion of housing 206. Pressure sensor 102 may be disposed internal to housing 206 adjacent to opening 208 to receive airflow from the external environment through opening 208.

Any or all of components 102, 104, 105, 116, 118, 120, 122, 124, 126, 128, and 130 of FIG. 1 may be disposed on or within housing 206. One or more additional openings in housing 206 may be provided for a speaker, a microphone, an ambient light sensor, and/or a proximity sensor. Strap 212 may be coupled to housing 206 at interfaces 214 and arranged to secure device 100 to a part of a user's body such as around the user's wrist.

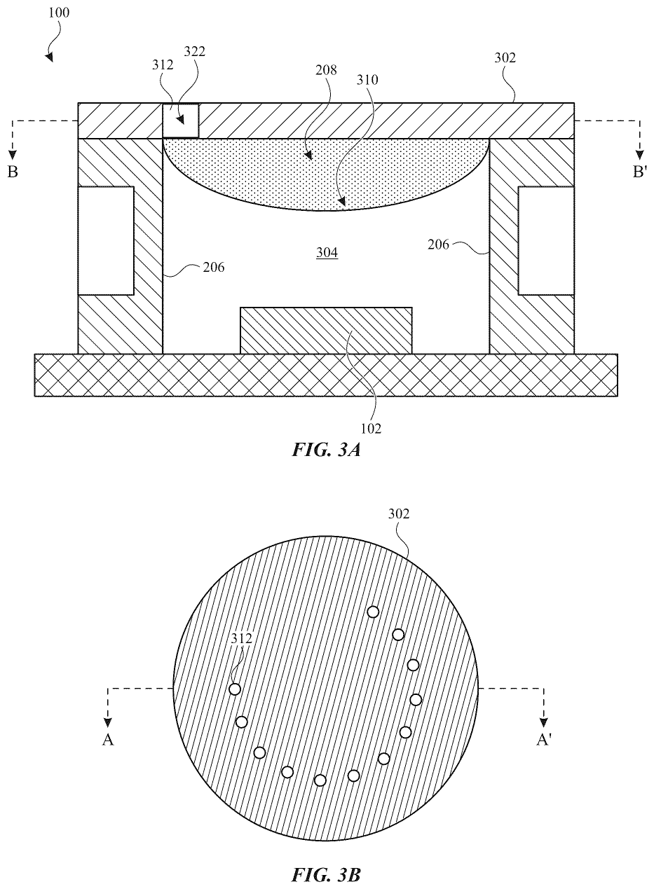

FIG. 3A illustrates a cross-sectional side view of a pressure sensor 102 disposed in a pressure sensor port in a housing 206 of an electronic device 100 in accordance with various aspects of the subject technology. Specifically, FIG. 3A shows a cross-sectional side view of a portion of device 100 at the location of opening 208 that is taken along section A-A′ in FIG. 3B. As shown in FIG. 3A, pressure sensor 102 is disposed within housing 206 adjacent to opening 208 in housing 206 such that pressure sensor 102 receives airflow through opening 208. A pressure sensor port for pressure sensor 102 is formed by opening 208 and a cavity 304, within housing 206 and adjacent to opening 208, within which pressure sensor 102 is disposed. The housing 206 can have a particular shape (e.g., cylindrical, square shape with rounded edges, rectangular shape with rounded edges, or the like) depending on implementation.

As also shown in FIG. 3A, the device 100 also includes a particulate protection element 302 disposed within the opening 208. In one or more implementations, the particulate protection element 302 may be a mesh or a protective cap. In one or more other implementations, the particulate protection element 302 includes gas permeable waterproof membranes, such as barometric vents. FIG. 3B illustrates a top view of the particulate protection element 302. In the example of FIG. 3B, the particulate protection element 302 is a protective cap. This protective cap can include multiple apertures 312 along an inner circumference of the protective cap that are intended to allow air passage into the cavity 304 while obstructing direct contact with environmental aggressors. The protective cap can serve the purpose of safeguarding any waterproofing encapsulation within the cavity 304 and maintaining pressure measurement functionality amidst liquid exposure. The apertures 312 can have a particular shape (e.g., round, square, rectangle, or the like) depending on implementation. Although FIG. 3B illustrates the particulate protection element 302 as a protective cap with multiple apertures arranged in a circular arrangement, one of ordinary skill in the art should appreciate that other types of caps and/or meshes with or without apertures may be implemented as the particulate protection element 302 without departing from the scope of the present disclosure.

In the example of FIG. 3A, pressure sensor 102 may be provided with access to the airflow from the external environment through opening 208. However, liquid (e.g., water, oil, soap, etc.) and/or other environmental aggressors such as dust or dirt may enter cavity 304 and occlude the pressure sensor 102 and/or the port formed by opening 208 and cavity 304 from receiving unobstructed airflow for environmental pressure sensing. In this regard, FIG. 3A illustrates a scenario in which liquid 310 has entered and partially filled cavity 304.

In the example of FIG. 3A, pressure sensor 102 may be a water-resistant pressure sensor having a waterproofing encapsulation such as a waterproofing gel disposed over the pressure sensor 102 to prevent liquid 310 from contacting the pressure sensor 102 electronics. This waterproofing gel, a polymer, facilitates pressure transmission to the pressure sensor 102 while preventing foreign particles or water from reaching the pressure sensor 102. However, liquid 310 that enters cavity 304 can impact the waterproofing encapsulation and can negatively affect the pressure measurements made using pressure sensor 102. Direct exposure of the waterproofing encapsulation to liquid 310 can cause deformation, affecting the performance of the pressure sensor 102.

In the example of FIG. 3A, there may exist an occlusion 322 in one of the apertures 312 of the particulate protection element 302. Liquid 310 infiltrates the space between the particulate protection element 302 and the waterproofing encapsulation, creating a concave air region where it becomes trapped due to the small size of the apertures 312, resulting in prolonged evaporation time. Consequently, the cavity 304 may become filled with liquid 310.

The occluding liquid 310 can cause pressure changes or variations at the pressure sensor 102. For example, liquid 310 getting trapped in cavity 304 due to film forming within the apertures 312 of the particulate protection element 302 can cause liquid 310 to accumulate in cavity 304, thereby generating an increase in pressure in cavity 304. This increase in pressure can, if the occlusion by liquid 310 is not detected, be falsely identified as a change in elevation of device 100.

In one or more implementations, the occlusion 322 may be detected by processing circuitry such as processing circuitry 128 of FIG. 1. Upon determination that the pressure sensor and/or the port formed by opening 208 and cavity 304 are occluded, the processing circuitry 128 can take corrective action. The corrective action may include operating an additional component within the housing 206 (e.g., a magnetic actuator) to clear the occlusion. In one or more other implementations, the processing circuitry 128 may take other corrective action, such as providing a notification to a user of device 100 that the pressure sensor is occluded, providing instructions to the user to clear the occlusion (e.g., by shaking the device or using a drying instrument in the port), preventing pressure sensor data obtained while the sensor was occluded from being used in other applications (e.g., to identify elevation changes and/or resulting exercise minutes), or providing an occlusion notice to other components and/or applications of the device 100 (e.g., to a speaker component to indicate the need to increase speaker volume).

The pressure sensor 102 can generate substantial errors in pressure readings when the pressure sensor 102 becomes wet. These errors may demonstrate significant fluctuations in the pressure readings. These errors can occur due to capillary forces exerting an additional force on the pressure sensor 102, causing a consequential pressure error. To mitigate the error occurrences, traditional approaches have involved temporarily restricting pressure data transmission from the device 100 for a defined duration of time (e.g., an hour) to allow for the trapped liquid 310 to evaporate from the occluded space.

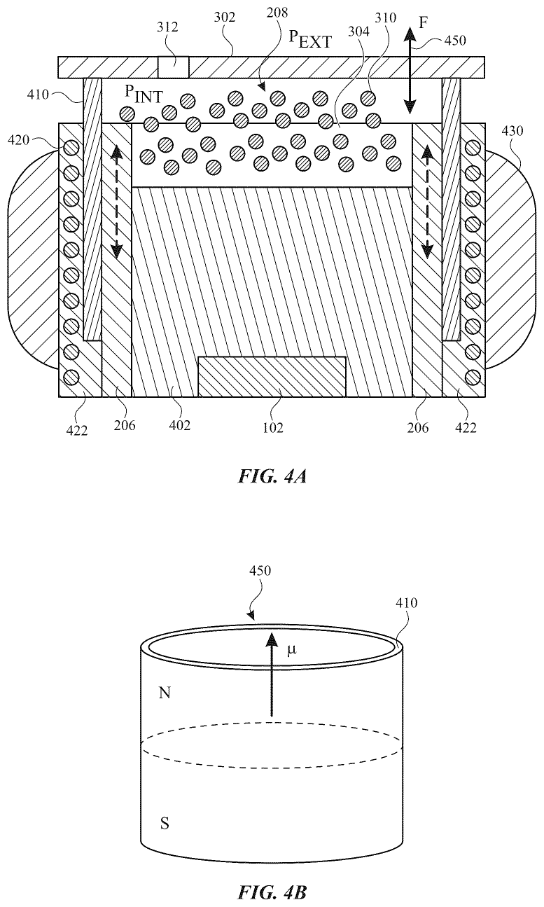

FIG. 4A illustrates a cross-sectional side view of a pressure sensor and a magnetic actuator disposed in a housing of an electronic device in accordance with various aspects of the subject technology. As shown in FIG. 4A, pressure sensor 102 is disposed within housing 206 adjacent to opening 208 in housing 206 such that pressure sensor 102 receives airflow through opening 208. A pressure sensor port for pressure sensor 102 is formed by opening 208 and a cavity 304, within housing 206 and adjacent to opening 208, within which pressure sensor 102 is disposed. The pressure sensor 102 may include an O-ring 430. The pressure sensor 102 integration within the electronic device 100 can involve the insertion of a sealing component into the pressure sensor port within a case of the electronic device 100, facilitated by the O-ring 430. This arrangement facilitates the impermeability of the electronic device 100 while allowing exposure of components such as a microphone or the pressure sensor 102 to the external environment. The O-ring 430 may prevent any potential leakage from the sealing component or the pressure sensor 102 into the internal space of the electronic device 100.

The pressure sensor 102 may be a water-resistant pressure sensor having a waterproofing encapsulation 402 such as a waterproofing gel disposed within the housing 206 and over the pressure sensor 102 to prevent liquid 310 from contacting the pressure sensor 102 electronics.

In the example of FIG. 4A, there may exist an occlusion in one of the apertures 312 of the particulate protection element 302. Liquid 310 infiltrates the space (e.g., cavity 304) between the particulate protection element 302 and the waterproofing encapsulation 402. The occluding liquid 310 can cause pressure changes or variations at the pressure sensor 102. For example, liquid 310 getting trapped in cavity 304 due to film forming within the apertures 312 of the particulate protection element 302 can cause liquid 310 to accumulate in cavity 304, thereby generating an increase in the interior pressure (denoted as Pᵢₙₜ) in cavity 304. Additionally, when the occluding liquid 310 does not entirely fill the internal volume (e.g., cavity 304) but instead obstructs the aperture 312 of the particulate protection element 302, the obstruction hinders air inflow, resulting in a pressure offset due to the inability to equalize pressure (e.g., between the interior pressure Pᵢₙₜ and exterior pressure Pₑₓₜ) within the cavity 304.

In one or more implementations, the magnetic actuator is a type of solenoid actuator that uses electromagnetism to generate motion. The magnetic actuator may include a cylindrical magnet (e.g., magnet 410) with a coil (e.g., coil 420) wound around it. In one or more implementations, the housing 206 may be coupled to a lead structure 422. In one or more other implementations, the housing 206 may be integrated with the lead structure 422, forming a monolithic structure. The lead structure 422 may be, or include at least in part, a concentric cylinder structure. In one or more implementations, the coil 420 is embedded within the lead structure 422. In one or more other implementations, the coil 420 is externally wrapped around the lead structure 422. In one or more implementations, the coupling between the lead structure 422 and the housing 206 forms a gap. The magnet 410 is positioned within the gap, resting on a section of the coil 420. In this regard, the magnet 410 can reside within the gap, enabling the movement of the magnet 410 within the gap in a direction of the repulsive force 450.

In the example of FIG. 4A, the magnet 410 is mechanically coupled to the particulate protection element 302 by way of a specific fastening method. For example, the outer edge of the cylinder-shaped magnet 410 may be fastened to an underside of the particulate protection element 302. In one or more implementations, the magnet 410 is permanently bonded to the particulate protection element 302 through a pressure sensitive adhesive or other analogous adhesive mechanism to secure these components together.

FIG. 4B conceptually illustrates a perspective view of the magnet in the magnetic actuator in accordance with various aspects of the subject technology. When an electric current passes through the coil 420, it generates a magnetic field around the coil 420. The generated magnetic field from the coil 420 interacts with the magnetic field of the magnet 410, resulting in a repulsive force 450. This repulsive force 450 opposes the magnetic field of the magnet 410, causing a pushing or repelling effect between the coil 420 and the magnet 410. This repulsive force 450 causes movement or displacement of the magnet 410. In the example of FIG. 4B, the magnet 410 includes both north and south poles. In one or more other implementations, the magnet 410 includes like poles facing each other (e.g., north-north, south-south).

The movement can be controlled by the processing circuitry 128 and utilized for exerting the occluded liquid out from the cavity 304. The strength of the repulsive force 450 and consequently the movement of the magnet 410 can be controlled by varying the current passing through the coil 420. For example, higher current can produce a stronger magnetic field and thus a stronger repulsive force 450.

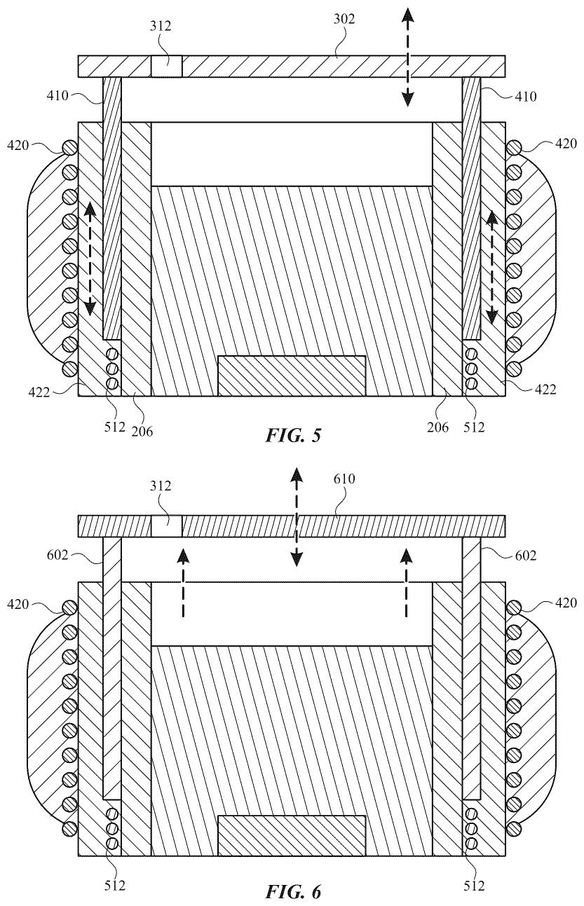

FIG. 5 illustrates a cross-sectional side view of a pressure sensor and another example of a magnetic actuator disposed in a housing of an electronic device in accordance with various aspects of the subject technology. The magnetic actuator illustrated in FIG. 5 is similar to the magnetic actuator illustrated in FIG. 4A with differences in the configuration of the magnet and coil arrangement without departing from the scope of the present disclosure. In the example of FIG. 5, the magnet 410 is coupled to the particulate protection element 302 by way of bonding or specific fastening method. In one or more implementations, the coil 420 is arranged external of the lead structure 422 and the housing 206, reducing the necessity for embedding within the lead structure 422, allowing flexibility in its placement.

Also in the example of FIG. 5, the lead structure 422 includes a spring structure 512 located beneath the placement of the magnet 410. The spring structure 512 facilitates the magnet 410 decompression after compression. This spring function performed by the spring structure 512 allows for the restoration of the magnet 410 to its original position following compression induced by the coil 420. For example, the spring structure 512 located underneath the magnet 410 in the example of FIG. 5 indicates a potential for sliding motion. The magnet 410 is configured to slide, requiring anchor points to prevent unintended movement within the gap. In one or more other implementations, the spring structure 512 may represent anchor points that serve to secure the magnet 410 in place, allowing the magnet 410 to remain stable and not allow it to dislodge completely from its position.

FIG. 6 illustrates a cross-sectional view of a pressure sensor and yet another example of a magnetic actuator disposed in a housing of an electronic device in accordance with various aspects of the subject technology. In the example of FIG. 6, a magnet serves as a protective cap 610, facilitating creating a magnetized protective cap. This configuration, in conjunction with the coil 420, generates a corresponding force. In the example of FIG. 6, the protective cap 610 is coupled to a cylinder structure 602 by way of bonding or specific fastening method. The cylinder structure 602 may serve as a support mechanism for the protective cap 610. In one or more other implementations, the protective cap 610 includes a magnetizable material, such as iron, reducing the necessity to inherently magnetize the protective cap 610. Instead, the coil 420 can induce magnetization in either the protective cap 610 or the cylinder structure 602, enabling their utilization as magnets after magnetization.

In the example of FIG. 6, the functionality involves the magnet positioned atop serving as the protective cap 610. The mechanism operates through the gradient of the magnetic field generated by the coil 420. When the coil 420 generates this magnetic field, the magnet included in the protective cap 610 moves along this gradient. In some instances, due to the kinetic field gradient, the magnet can move toward the coil 420 until the gradient zeroes, halting the magnet's movement. Subsequently, the spring structure 512 facilitates the return of the magnet. For example, the spring structure 512 facilitates the return of the magnet to its initial position, due to the inability to push the magnet back manually. Rather than the magnet sliding inside the coil as illustrated in FIG. 5, for example, the magnet is drawn toward the coil 420, akin to two magnets being drawn together.

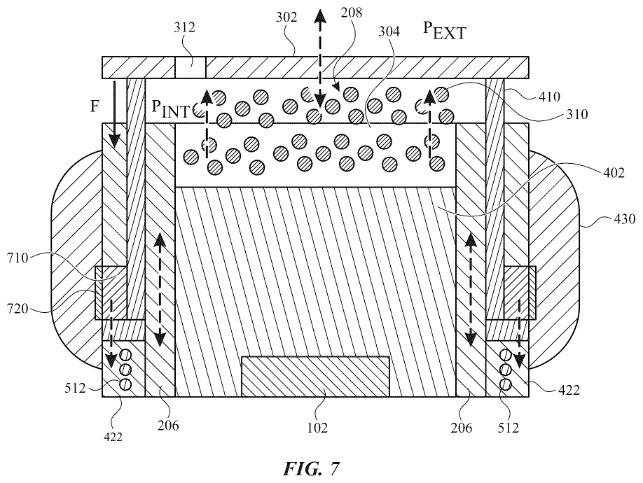

FIG. 7 illustrates a cross-sectional side view of a pressure sensor and an example of a magnetic actuator and a heater disposed in a housing of an electronic device in accordance with various aspects of the subject technology. The magnetic actuator illustrated in FIG. 7 is similar to the magnetic actuator illustrated in FIG. 4A with differences in the introduction of an expansion material 710 and a heater 720 without departing from the scope of the present disclosure.

As shown in FIG. 7, pressure sensor 102 is disposed within housing 206 adjacent to opening 208 in housing 206 such that pressure sensor 102 receives airflow through opening 208. A pressure sensor port for pressure sensor 102 is formed by opening 208 and the cavity 304, within housing 206 and adjacent to opening 208, within which pressure sensor 102 is disposed. The pressure sensor 102 may include the O-ring 430. The pressure sensor 102 may include the waterproofing encapsulation 402 such as a waterproofing gel disposed within the housing 206 and over the pressure sensor 102 to prevent liquid 310 from contacting the pressure sensor 102 electronics. In the example of FIG. 7, the magnet 410 is coupled to the particulate protection element 302 by way of bonding or specific fastening method. The particulate protection element 302 may be a protective cap that includes multiple apertures 312.

Also in the example of FIG. 7, the lead structure 422 includes the spring structure 512 located beneath the placement of the magnet 410. The spring structure 512 facilitates the magnet 410 decompression after compression. This spring function performed by the spring structure 512 allows for the restoration of the magnet 410 to its original position following compression induced by the expansion material 710. For example, the spring structure 512 located underneath the magnet 410 in the example of FIG. 7 indicates a potential for sliding motion. The magnet 410 is configured to slide, requiring anchor points to prevent unintended movement within the gap. In one or more other implementations, the spring structure 512 may represent anchor points that serve to secure the magnet 410 in place, allowing the magnet 410 to remain stable and not allow it to dislodge completely from its position.

In one or more implementations, the heater 720 may be coupled to a sidewall of the lead structure 422 and located proximate to the expansion material 710. In one or more other implementations, the heater 720 is located between the O-ring 430 and the expansion material 710. In one or more implementations, the expansion material 710 is arranged within the lead structure 422 and positioned on a base structure coupled to the magnet 410.

In one or more implementations, the expansion material 710 is utilized, which exhibits expansion properties when subjected to heating by the heater 720. The expansion material may consist of a substance with a high coefficient of thermal expansion (CTE) or a gaseous medium, such as air, that expands upon heating. Upon activation of the heater 720, the resulting thermal energy causes the expansion material 710 to increase in volume. This volumetric increase can exert a downward force on the magnet 410. When heated, the expansion material 710 can expand and place a downward force onto the base structure, displacing the magnet 410 with a downward force and compressing the spring structure 512 to a compressed position. As the magnet 410 is displaced, the liquid 310 is subsequently ejected from the cavity 304. Upon deactivation of the heater 720, the expansion material 710 may decrease in volume to its original state, causing the spring structure 512 to decompress to a decompressed position and returning the magnet 410 to its original resting position.

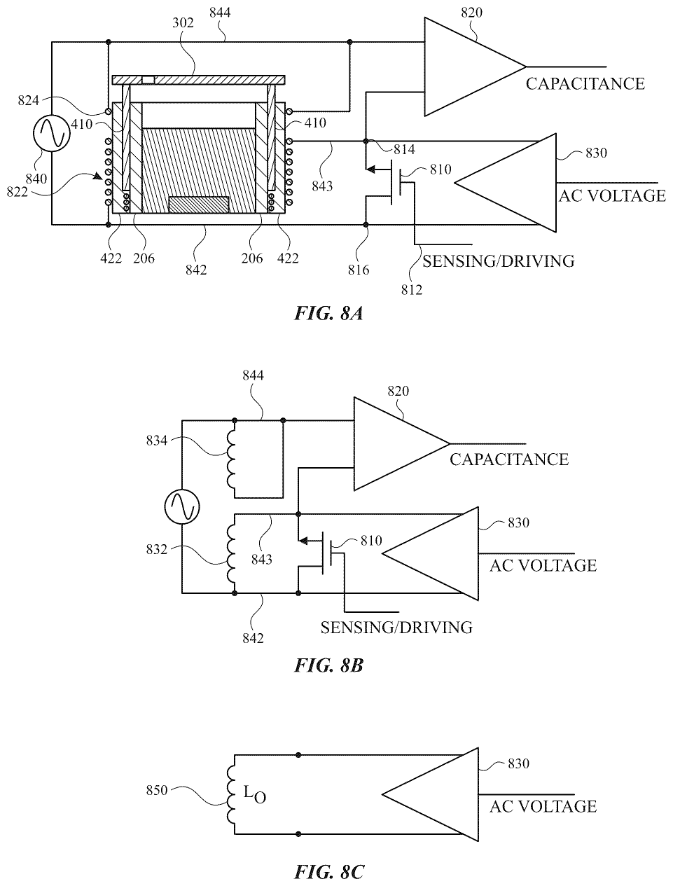

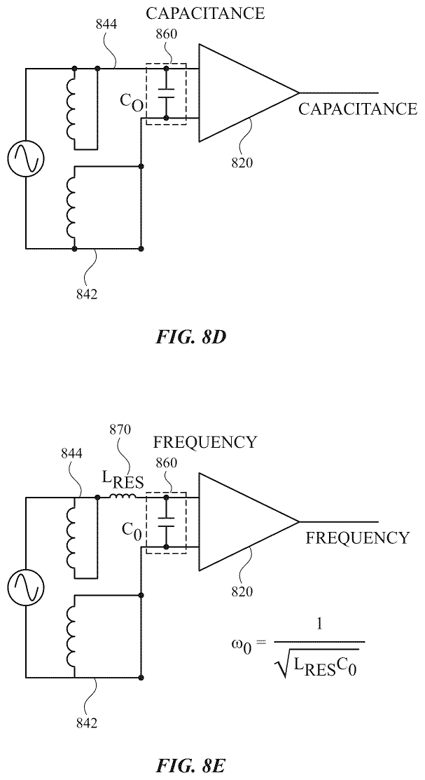

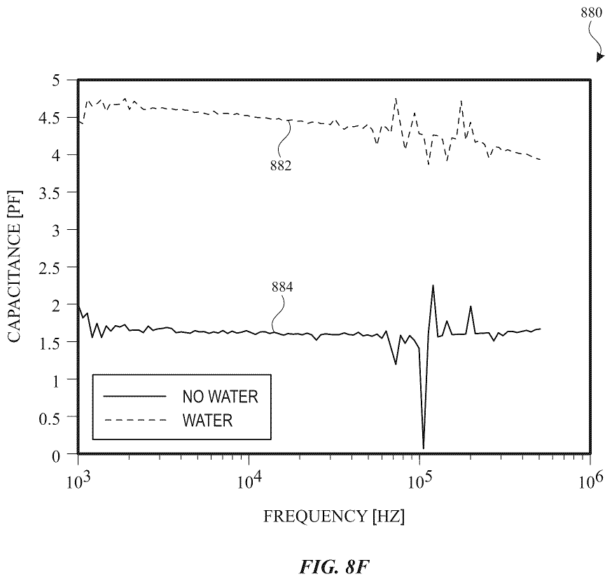

FIG. 8A illustrates a pressure sensor and an example of a magnetic actuator with sensing and driving circuits in accordance with various aspects of the subject technology. In contrast to the implementation of a single coil and magnet arrangement throughout the pressure sensor body as illustrated in FIGS. 4A, 5 and 6, the example in FIG. 8A incorporates two components: a primary winding 822 arranged around a first portion of the magnet 410 and a secondary winding 824 arranged around a second portion of the magnet 410. In one or more implementations, the first portion of the magnet 410 is located below or located lower than the second portion of the magnet 410. The secondary winding 824 may be implemented as a ring-like structure. The example illustrated in FIGS. 4A, 5 and 6 depicted a single coil lacking a sensing mechanism. In the example of FIG. 8A, the primary winding 822 wrapped around the first portion of the magnet 410 is implemented similar to the single coil arrangement illustrated in FIGS. 4A, 5 and 6.

In the example of FIG. 8A, the magnet 410 is coupled to the particulate protection element 302 by way of bonding or specific fastening method. In one or more implementations, the primary winding 822 and the secondary winding 824 are arranged external of the lead structure 422 and the housing 206. In one or more implementations, the electronic device 100 maintains a separation between the two coils (e.g., primary winding 822, secondary winding 824) or electrodes, reducing the need for electrical connection between them.

In one or more implementations, the primary winding 822 is connected to a first terminal of a power supply 840 and the secondary winding 824 is connected to a second terminal of the power supply 840. The power supply 840 may be a voltage supply that operates in the range of 1.2 V to 1.8 V, aligning with supply parameters of the electronic device 100.

In one or more implementations, the primary winding 822 and the secondary winding 824 can be manipulated for sensing purposes. In the example of FIG. 8A, the primary winding 822 is connected to a first input of sensing device 820 along circuit path 843 and the secondary winding 824 is connected to a second input of the sensing device 820 along circuit path 844. As illustrated in FIG. 8A, one end of the primary winding 822 is connected to the first terminal of the power supply 840 along circuit path 842 and the opposite end of the primary winding 822 is connected to the sensing device 820 at node 814 along the circuit path 843.

The sensing device 820 can measure a capacitance between the primary winding 822 and the secondary winding 824. As a liquid, such as water, possesses a higher dielectric constant, its presence within the cavity 304 causes a shift in capacitance between the primary winding 822 and the secondary winding 824. This change in capacitance can serve as a mechanism for liquid occlusion detection within the pressure sensor 102.

The power supply 840 can supply power to the primary winding 822 and the secondary winding 824, involving two terminals for current flow. For sensing, the primary winding 822 and the secondary winding 824 can be merged effectively, forming a substantial ring-like structure. This combination facilitates the measurement of changes in capacitance for sensing purposes.

The primary winding 822 and the secondary winding 824 may have distinct characteristics between them. This differentiation can encompass factors such as the produced inductance, the gauge of the wiring, the capacity to receive current, or any other relevant features that delineate their individual functionalities. In one or more other implementations, there may be a relationship between the primary winding 822 and the secondary winding 824. In one or more other implementations, the primary winding 822 and the secondary winding 824 may be defined by an inductance ratio between the primary winding 822 and the secondary winding 824.

In one or more implementations, the sensing mechanism may not be defined by the geometry but rather constrained by the integration due to the pressure sensor module's dimensions, which may span approximately three millimeters in width and around one and a half millimeters in height. Consequently, the wire gauges of the primary winding 822 and the secondary winding 824 can be relatively small to facilitate their wrapping around the pressure sensor 102 including the magnet 410 of the magnetic actuator, thereby dictating the constraints imposed on integration.

The driving mechanism for liquid occlusion ejection purposes incorporates a voltage driver 830 and a switch 810 regulated by a sensing/driving control signal 812. In one or more implementations, the switch 810 may be a semiconductor device such as a transistor. In one or more implementations, the voltage driver 830 may be implemented as an amplifier. The gate terminal of the switch 810 can be managed by the sensing/driving control signal 812. In one or more implementations, the sensing/driving control signal 812 may be driven by a digital input/output interface originating from within the electronic device 100. The source terminal of the switch 810 is connected to one end of the primary winding 822 at node 816 along the circuit path 842. The drain terminal of the switch 810 is connected to the other end of the primary winding 822 at node 814 along the circuit path 843.

Activating the switch 810 can enable magnet propulsion by utilizing the voltage driver 830 to conduct current through the primary winding 822. Conversely, deactivating the switch 810, prompted by the sensing/driving control signal 812, closes the switch 810, facilitating capacitance measurement between the primary winding 822 and the secondary winding 824. When the switch 810 is closed, the primary winding 822 may transform into a large self-wrapped metal piece, in one or more implementations. In one or more implementations, the voltage driver 830 is driven by an alternating current (AC) voltage.

The control mechanism for the AC voltage line input to the voltage driver 830 can involve various integration strategies. In one or more implementations, the control mechanism for the AC voltage line can be pre-programmed onto the voltage driver 830, allowing for the storage of a specific signature within the voltage driver 830. In one or more other implementations, the control mechanism for the AC voltage line can be stored within a System-on-Chip (SoC), which serves as a central processing unit of the electronic device 100.

In one or more implementations, the sensing mechanism and driving mechanism can perform simultaneous driving and sensing operations. In this regard, the sensing mechanism may be activated to detect the initial capacitance between the primary winding 822 and the secondary winding 824 to determine the presence or absence of any liquid occlusion and its quantity, triggering activation of the magnet 410 if certain thresholds are met. Upon detecting a higher capacitance that is indicative of a liquid occlusion presence, the processing circuitry 128 can activate the magnet 410 for liquid occlusion ejection. Subsequent sensing aims to revert the capacitance levels to their initial state, confirming successful liquid occlusion ejection.

The activation of the magnet 410 can involve utilizing the voltage driver 830 to power the magnet 410. Initially, the pressure sensor 102 sets the sensing mechanism to determine the initial state of the pressure sensor area, recognizing the presence of any liquid occlusion. This can lead to a fixed logic or control signal (e.g., AC voltage line) initiating the magnet driving sequence. The AC voltage variations between the scenarios encompass differences in frequency and potentially slight variations in amplitude. These amplitude adjustments may relate to changes in inductance, impacting the voltage detected by the primary winding 822, while fundamentally maintaining the same signal across different frequencies.

The AC voltage waveforms may be pre-programmed based on the sensed data. When the capacitance reading surpasses a predefined threshold, these waveforms can trigger the AC voltage sequences. Subsequent sensing can occur after this initial sensing phase, maintaining a feedback loop between the initial presence of liquid occlusion and final non-presence of liquid occlusion. As such, the subject technology provides for eliminating the liquid occlusion within the first cycle, reducing the necessity for multiple iterations.

During operation, the duration for bulk liquid ejection may be for a period of one to two seconds, whereas droplet ejection may target a timeframe in the order of milliseconds. In terms of short-duration pulses intended for rapid action, their amplitude is expected to be higher compared to long-duration pulses. These short pulses may be characterized by quick, intense peaks. Conversely, the long-duration pulses aimed at expelling residual liquid entail lower amplitude and prolonged durations.

FIGS. 8B-8E conceptually illustrate equivalent circuits of the pressure sensor and magnetic actuator with the sensing and driving circuits of FIG. 8A in accordance with various aspects of the subject technology. In the example of FIG. 8B, the primary winding 822 can be represented with an equivalent circuit implemented as inductor 832 and the secondary winding 824 can be represented with an equivalent circuit implemented as inductor 834. In this regard, the sensing device 820 can measure the capacitance along circuit path 843 and circuit path 844 to determine a change in capacitance between the inductor 832 and the inductor 834. The voltage driver 830 can supply a driving signal across the inductor 832 via the circuit path 842 and 843 when the sending/driving control signal activates the switch 810.

In the example of FIG. 8C, the primary winding 822 and the switch 810 can be represented with an equivalent circuit implemented as inductor 850 connected to output terminals of the voltage driver 830. In this regard, the voltage driver 830 can supply the driving signal across the inductor 850 using the input AC voltage signal. In the example of FIG. 8D, the sensing device 820 can measure a capacitance 860 (denoted as Cₒ) that represents the capacitance between the circuit path 842 and the circuit path 844.

In the frequency sensing as illustrated in the example of FIG. 8E, the inclusion of inductor 870 (denoted as L_{RES}) in series along the circuit path 844 to the second input of the sensing device 820 can either constitute an additional component or remain a pre-existing element within the circuit path 844. The sensing device 820 may perform a direct capacitance reading in one or more implementations or monitor changes in the resonance peak of an isolator in one or more other implementations. The inductor 870 may induce a specific frequency response, such that the sensing device 820 can detect changes in capacitance by observing shifts in the resonance frequency. In some aspects, resonance-based readings may exhibit higher sensitivity to capacitance changes compared to standalone capacitance measurements.

FIG. 8F illustrates a two-dimensional graph depicting a plot 880 of an example sensing mechanism with the magnetic actuator of FIG. 8A in accordance with various aspects of the subject technology. The plot 880 illustrates a correlation in capacitance levels between the presence of liquid and absence of liquid within the pressure sensor 102. For example, higher capacitance values indicate liquid detection, whereas lower capacitance values signify the absence of liquid. In the example of FIG. 8F, the plot 880 includes a first waveform 882 representing the presence of liquid within the pressure sensor 102 at capacitance values in the range of about 3.5 pF to about 4.5 pF. The plot 880 also includes a second waveform 884 representing the absence of liquid within the pressure sensor 102 at capacitance values in the range of about 0 pF to about 2.5 pF over a span of frequencies. The capacitance values illustrated in FIG. 8F are merely illustrative and can vary depending on implementation without departing from the scope of the present disclosure.

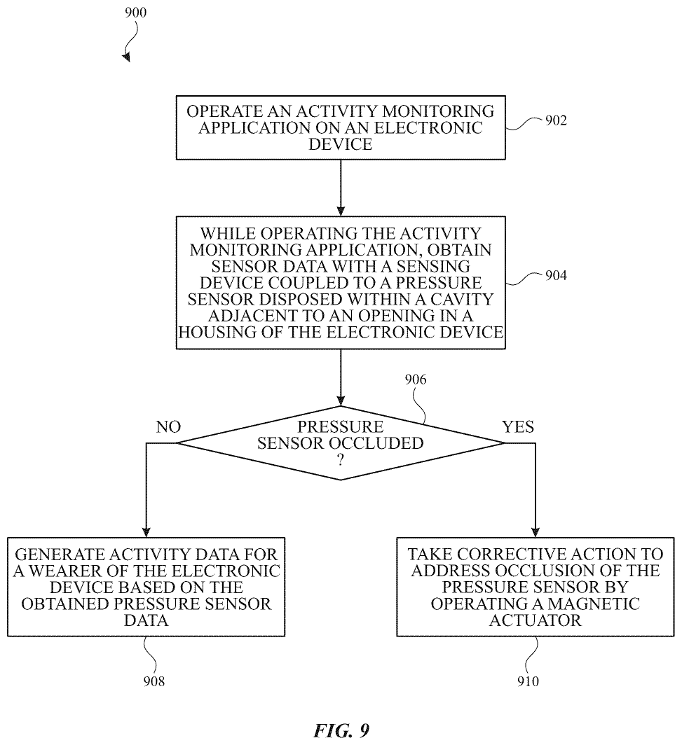

FIG. 9 depicts a flow diagram of an example process for operation of device 100, in accordance with various aspects of the subject technology. For explanatory purposes, the example process of FIG. 9 is described herein with reference to the components of FIGS. 4A-4B, 5, 6, 7 and 8A-8F. Further for explanatory purposes, some blocks of the example process of FIG. 9 are described herein as occurring in series, or linearly. However, multiple blocks of the example process of FIG. 9 may occur in parallel. In addition, the blocks of the example process of FIG. 9 need not be performed in the order shown and/or one or more of the blocks of the example process of FIG. 9 need not be performed.

In the depicted example flow diagram, at step 902, an activity monitoring application of a wearable electronic device 100 such as smart watch of FIG. 2 may be operated. Operating the activity monitoring application may include monitoring an activity of a wearer of a smart watch with the activity monitoring application of the smart watch (e.g., by monitoring the position, motion, elevation, acceleration, and/or position of device 100 using various sensors within the device 100).

At step 904, while operating the activity monitoring application, sensor data may be obtained with a sensing device coupled to a pressure sensor (e.g., pressure sensor 102) disposed adjacent an open port (e.g., opening 208) in a housing (e.g., housing 206) of the wearable electronic device. In one or more implementations, the sensor data includes capacitance measurements. In this regard, the sensor data may indicate a change in capacitance that meets or does not meet certain threshold levels. In one or more other implementations, the sensor data include frequency measurements. In this regard, the frequency measurements may be indicative of the change in capacitance.

At step 906, processing circuitry such as processing circuitry 128 determines whether the pressure sensor and/or the open port are occluded based on the sensor data (e.g., by analyzing the sensor data). For example, occlusion may be detected when a change in capacitance within a specific window of time exceeds a certain threshold.

At step 908, if no occlusion is detected, activity data such as exercise statistics may be generated for a wearer of the wearable electronic device (e.g., using the pressure data by converting a barometric pressure measured by the pressure sensor into a device elevation). For example, one or more flights of stairs may be awarded to the wearer using a change in elevation determined using the determined measured pressure.

At step 910, if occlusion is detected, processing circuitry such as processing circuitry 128 may proceed to take corrective action to address occlusion of the pressure sensor or the open port. Correction action can include, as one example, rejecting the pressure sensor data from inclusion in determining exercise statistics for the wearer of device 100. In one or more implementations, a magnetic actuator disposed in the device 100 may be operated to mitigate the occlusion. In one or more implementations, the magnetic actuator may be a magnet and a coil wrapped around the magnet that are disposed in opening 208. The magnetic actuator may be operated to generate motion to facilitate ejection of a liquid occlusion with the generated motion, as described with reference to FIGS. 4A-4B, 5, 6, 7 and 8A-8F.

Although the example of FIG. 9 describes the use of pressure sensor data (and associated occlusion detection operations) in the context of determining exercise statistics by an activity monitoring application of a wearable electronic device, it will be appreciated that the occlusion detection operations described herein can be applied to pressure sensors disposed in other devices and used for other applications, some examples of which have been described herein.

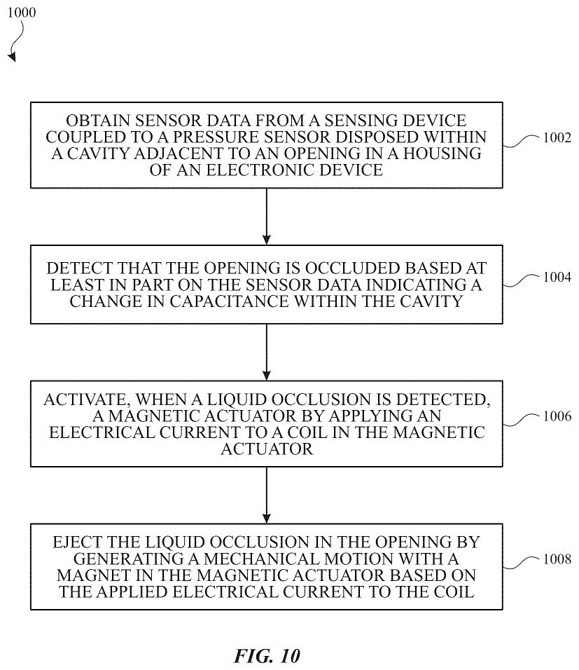

FIG. 10 depicts a flow diagram of an example process for determining whether the pressure sensor and/or the open port are occluded, in accordance with various aspects of the subject technology. For explanatory purposes, the example process of FIG. 10 is described herein with reference to the components of FIGS. 1-3A, 3B, 4A-4B, 5, 6, 7 and 8A-8F. Further for explanatory purposes, some blocks of the example process of FIG. 10 are described herein as occurring in series, or linearly. However, multiple blocks of the example process of FIG. 10 may occur in parallel. In addition, the blocks of the example process of FIG. 10 need not be performed in the order shown and/or one or more of the blocks of the example process of FIG. 10 need not be performed.

At step 1002, sensor data may be obtained with a sensing device coupled to a pressure sensor (e.g., pressure sensor 102) disposed within a cavity (e.g., cavity 304) adjacent to an open port (e.g., opening 208) in a housing (e.g., housing 206) of the wearable electronic device (e.g., device 100). In one or more implementations, the sensor data may be indicative of capacitance measurements. In one or more other implementations, the sensor data may indicate a change in capacitance.

At step 1004, processing circuitry such as processing circuitry 128 detects that the pressure sensor and/or the open port are occluded based at least in part on the sensor data indicating a change in capacitance within the cavity 304. For example, a liquid occlusion is detected when the change in capacitance over a specific window of time as indicated by the sensor data satisfies certain criteria indicative of occlusion.

At step 1006, processing circuitry such as processing circuitry 128 activates, when a liquid occlusion is detected, a magnetic actuator (e.g., magnet 410 and coil 420) by applying an electrical current to the coil 420.

At step 1008, the magnetic actuator ejects the liquid occlusion in the opening by generating a mechanical motion with the magnet 410 based on the applied electrical current to the coil 420. In this regard, the generated motion may displace at least a portion of the occluded water trapped inside the cavity to be expelled out of the cavity.

In accordance with various aspects of the subject disclosure, a smart watch is provided that includes a housing having an opening. The smart watch also includes a pressure sensor disposed within a cavity adjacent to the housing and exposed to an environment external to the housing via the opening. The smart watch also includes a magnetic actuator coupled to the pressure sensor, wherein the magnetic actuator comprises a primary winding and a secondary winding wrapped around a magnet. The smart watch also includes a switch coupled to the primary winding and the secondary winding. The smart watch also includes a sensing device coupled to the primary winding and the secondary winding via the switch and is configured to measure a change in capacitance between the primary winding and the secondary winding to detect a liquid volume within the cavity. The smart watch also includes a voltage driver coupled to the primary winding via the switch and is configured to apply, when the liquid volume is detected, an electrical current to the primary winding to generate a motion with the magnet and displace at least a portion of the liquid volume inside the cavity by causing a repulsive force with the generated motion.

In accordance with other aspects of the subject disclosure, a method is provided that includes detecting that the opening is occluded; activating, when a liquid occlusion is detected, the magnetic actuator by applying an electrical current to a coil in the magnetic actuator; and ejecting the liquid occlusion in the opening by generating a mechanical motion with a magnet in the magnetic actuator based on the applied electrical current to the coil.

In accordance with other aspects of the subject disclosure, an electronic device is provided that includes a housing having an opening. The electronic device also includes a pressure sensor disposed within a cavity adjacent to the opening and exposed to an environment external to the housing via the opening. The electronic device also includes a magnetic actuator associated with the pressure sensor. The electronic device also includes processing circuitry configured to detect that the opening is occluded; activate, when a liquid occlusion is detected, the magnetic actuator by applying an electrical current to a coil in the magnetic actuator; and eject the liquid occlusion in the opening by generating a mechanical motion with a magnet in the magnetic actuator based on the applied electrical current to the coil.

In accordance with other aspects of the subject disclosure, an apparatus is provided that includes a housing having an opening. The apparatus also includes a particulate protection element disposed within the opening. The apparatus also includes a pressure sensor disposed within a cavity adjacent to the opening and exposed to an environment external to the housing via the opening. The apparatus also includes a magnetic actuator coupled to the pressure sensor. The apparatus also includes a sensing device coupled to the magnetic actuator and configured to detect a liquid occlusion in one or more apertures of the particulate protection element. The apparatus also includes a voltage driver coupled to the magnetic actuator and configured to apply, when the liquid occlusion is detected, an electrical current to the magnetic actuator and causing the magnetic actuator to generate a motion with a repulsive force to expel the liquid occlusion in the one or more apertures of the particulate protection element.

Various functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “processor”, and “memory” all refer to electronic or other technological devices. These terms exclude people or groups of people. For the purposes of the specification, the terms “display” or “displaying” means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device as described herein for displaying information to the user and a keyboard and a pointing device, such as a mouse or a trackball, by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, flash drives, RAM chips, solid-state drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Some of the blocks may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “example” is used herein to mean “serving as an example or illustration.” Any aspect or design described herein as “example” is not necessarily to be construed as preferred or advantageous over other aspects or design.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. An electronic device, comprising:
a housing having an opening;
a pressure sensor disposed within a cavity adjacent to the opening and exposed to an environment external to the housing via the opening;
a magnetic actuator associated with the pressure sensor; and
processing circuitry configured to:
detect that the opening is occluded;
activate, when a liquid occlusion is detected, the magnetic actuator by applying an electrical current to a coil in the magnetic actuator; and
eject the liquid occlusion in the opening by generating a mechanical motion with a magnet in the magnetic actuator based on the applied electrical current to the coil.

2. The electronic device of claim 1, wherein the magnetic actuator comprises the magnet and the coil wrapped around the magnet.

3. The electronic device of claim 1, wherein the coil is embedded within a lead structure that is coupled to the magnet and the housing, wherein the lead structure is wrapped around the magnet.

4. The electronic device of claim 1, wherein the coil is arranged external to a lead structure and the coil is wrapped around the lead structure and the magnet.

5. The electronic device of claim 4, wherein the lead structure includes a spring structure configured to return the magnet to an initial position following the mechanical motion.

6. The electronic device of claim 1, wherein the magnet is arranged in a gap formed between a lead structure and the housing.

7. The electronic device of claim 1, wherein the magnet is coupled to a particulate protection element having a plurality of apertures, wherein the particulate protection element is arranged across the opening, and wherein the processing circuitry is further configured to detect the liquid occlusion in one or more apertures of the plurality of apertures.

8. The electronic device of claim 1, wherein the magnet is arranged as a protective cap mounted on a cylinder structure coupled between a lead structure and the housing, wherein the coil is external to the lead structure and the coil is wrapped around the lead structure.

9. The electronic device of claim 1, wherein the processing circuitry includes a sensing device coupled to the magnetic actuator and is configured to detect the liquid occlusion.

10. The electronic device of claim 9, wherein the magnetic actuator includes another coil electrically separate from the coil that is coupled to the sensing device, wherein the sensing device is configured to measure a change in capacitance between the coil and the other coil.

11. The electronic device of claim 1, wherein the processing circuitry includes a driver coupled to the magnetic actuator and is configured to apply the electrical current to the coil.

12. The electronic device of claim 1, wherein the processing circuitry includes a switch configured to initiate sensing between a first coil and a second coil in the magnetic actuator based on a first control signal value, wherein the switch is further configured to activate the magnetic actuator by passing the electrical current to the first coil based on a second control signal value.

13. An apparatus, comprising:
a housing having an opening;
a particulate protection element disposed within the opening;
a pressure sensor disposed within a cavity adjacent to the opening and exposed to an environment external to the housing via the opening;
a magnetic actuator coupled to the pressure sensor;
a sensing device coupled to the magnetic actuator and configured to detect a liquid occlusion in one or more apertures of the particulate protection element; and
a voltage driver coupled to the magnetic actuator and configured to apply, when the liquid occlusion is detected, an electrical current to the magnetic actuator and causing the magnetic actuator to generate a motion with a repulsive force to expel the liquid occlusion in the one or more apertures of the particulate protection element.

14. The apparatus of claim 13, wherein the magnetic actuator comprises a magnet and a coil wrapped around the magnet.

15. The apparatus of claim 14, wherein the magnetic actuator includes another coil electrically separate from the coil that is coupled to the sensing device, wherein the sensing device is configured to measure a change in capacitance between the coil and the other coil.

16. The apparatus of claim 13, further comprising a switch configured to initiate sensing between a first coil and a second coil in the magnetic actuator based on a first control signal value, wherein the switch is further configured to activate the magnetic actuator by passing the electrical current to the first coil based on a second control signal value.

17. The apparatus of claim 13, wherein the magnetic actuator comprises a coil and a magnetic, wherein the coil is embedded within a lead structure that is coupled to the magnet and the housing, wherein the lead structure is wrapped around the magnet.

18. The apparatus of claim 13, wherein the magnetic actuator comprises a coil and a magnetic, wherein the coil is arranged external to a lead structure and the coil is wrapped around the lead structure and the magnet.

19. The apparatus of claim 13, wherein the magnetic actuator comprises a magnetic, wherein the magnet is arranged in a gap formed between a lead structure and the housing.

20. A smart watch, comprising:
a housing having an opening;
a pressure sensor disposed within a cavity adjacent to the housing and exposed to an environment external to the housing via the opening;
a magnetic actuator coupled to the pressure sensor, wherein the magnetic actuator comprises a primary winding and a secondary winding wrapped around a magnet;
a switch coupled to the primary winding and the secondary winding;
a sensing device coupled to the primary winding and the secondary winding via the switch and is configured to measure a change in capacitance between the primary winding and the secondary winding to detect a liquid volume within the cavity; and
a voltage driver coupled to the primary winding via the switch and is configured to apply, when the liquid volume is detected, an electrical current to the primary winding to generate a motion with the magnet and displace at least a portion of the liquid volume inside the cavity by causing a repulsive force with the generated motion.
